(19) United States
(12) Patent Application Publication
(10) Pub. No.: US 2006/0244250 A1
(43) Pub. Date: Nov. 2, 2006

(54) Emergency anchoring device for recreational vehicles

(76) Inventor: Jeannot Desjardins, Laprairie (CA)

Correspondence Address: INVENTARIUM, Suite 1607, 4050 Rosemont blvd, Montreal, QC, H1X 1M4, CA

(21) Appl. No.: 11/453,617

(22) Filed: Jun. 15, 2006

Related U.S. Application Data
(63) Continuation-in-part of application No. 10/984,715, filed on Nov. 10, 2004.

(51) Int. Cl. B60S 9/02

(52) U.S. Cl. 280/763.1

(57) ABSTRACT

An emergency anchoring device for recreational vehicles has a body having a pointed end and that body has three fold lines with one of the fold lines being in the middle of the body while the other fold lines are paired, one on each side of the middle fold line so as to create folds from which extend wings. A primary arm rotationally attached to the body by way of an adjustable attachment means has a hook at its distal end.

This application is a continuation in part of application Ser. No. 10/984,715 filed Nov. 10, 2004

### BACKGROUND OF THE INVENTION

1. Field of the Invention

The invention relates generally to anchors but more particularly to an emergency anchoring device for recreational vehicles.

2. Background of the Invention

Anchors are generally known for ships but the general term also describes hooks that are planted into the ground in order to serve as a relatively fixed and secure point onto which an attachment can be secured. In this regard, a number of stakes, plows or hooks have been developed over the years for certain specific applications.

Because of a lack of practical anchoring devices that are compact for easy storage when not required, this inventor came up with his emergency anchoring device for recreational vehicles described in previous patent application Ser. No. 10/984,715 filed Nov. 10, 2004 and incorporated herein by reference.

Although the invention solved many issues, it was found that, when applied to field use, there were a number of weaknesses and there was therefore a need for improvement to solve those weaknesses and make the device more reliable, sturdy, and practical.

### SUMMARY OF THE INVENTION

In view of the foregoing lack of known devices now present in the prior art, the present invention provides an emergency anchoring device for use when a recreational vehicle such as a snowmobile or ATV is stuck in mud, snow, or in a ditch.

The main advantages are to have a head onto which pounding is done to engage the anchoring device is stronger since it rests upon an extension extending from the body. Furthermore, the manner in which the primary arm is rotationally attached to an adjustable attachment means provides for improved rotational capabilities as well as better adjustment to secure the primary arm in a given configuration has a hook at its distal end.

More generally, the present invention has a body having a pointed end and that body has three fold lines with one of the fold line being in the middle of the body while the other fold lines are paired, one on each sides of the middle fold line so as to create folds from which extend wings.

A primary arm rotationally attached to the body by way of an adjustable attachment means has a hook at its distal end.

In a variation of the invention, there is a secondary arm, configured and sized to fit within the primary arm so that it can be retracted and protracted in relation with the primary arm. The secondary arm also has a hook at one of its ends.

In yet another variation, the anchoring device has a re-enforced head at its end opposite the pointed end.

In a preferred embodiment, the adjustable attachment means has a nut which engages into complementary notches which are conjoined with the attachment means. The nut allows for rotational connection between the attachment means and an extension extending from the body. The extension is fixedly attached to the body. This adjustable attachment means has the following method of use: Removing a clip passing through a shaft, part of said nut allows the nut to disengage from the notches, which allows rotation of the primary arm so that it can be oriented to any desired angle in relation to the body. One orientation of the primary arm is obtained, the nut is pushed back into the notches and the clip is clipped back through the shaft so as to lock the nut in place.

In one embodiment, the secondary arm has at least one adjustment hole that allows passage of an adjustment bolt used when the secondary arm is inserted through the distal end, a plurality of such adjustment holes can provide for a plurality of adjustment lengths for the secondary arm. The adjustment bolt is preferably of the threadable kind and is preferably threadably engaged to at least one of the secondary or primary arm.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustraterd a preferred embodiments of the invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE PREFERRED EMBODIMENT

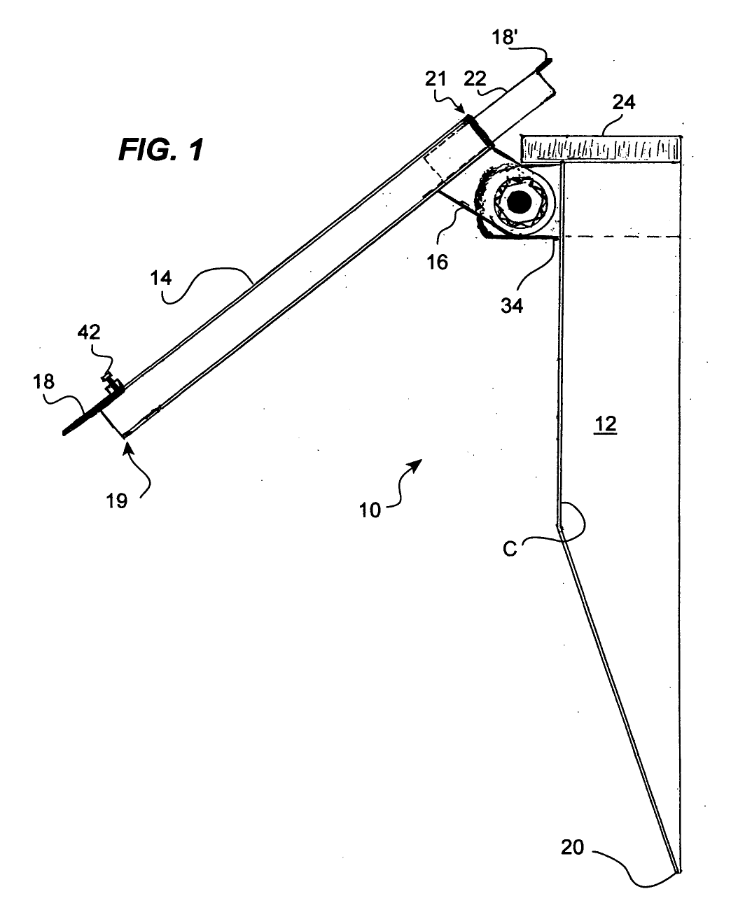

FIG. 1 Side view with the primary arm in a semi open position and with the secondary arm extending from the proximal end of the primary arm.

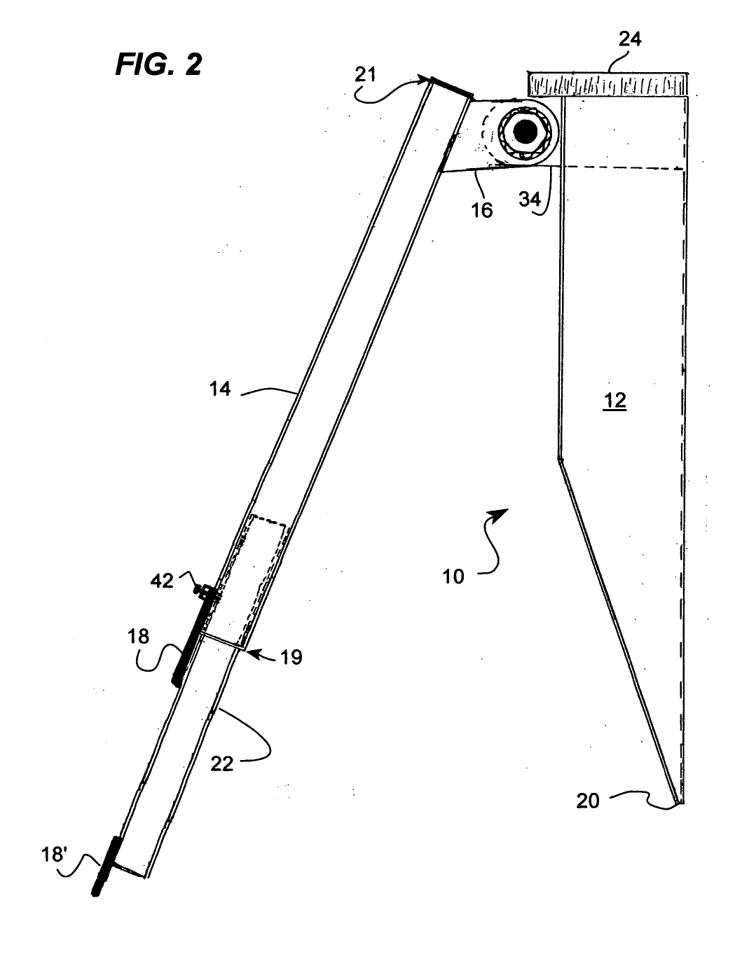

FIG. 2 Side view with the primary arm in a semi closed position and with the secondary arm extending from the distal end of the primary arm.

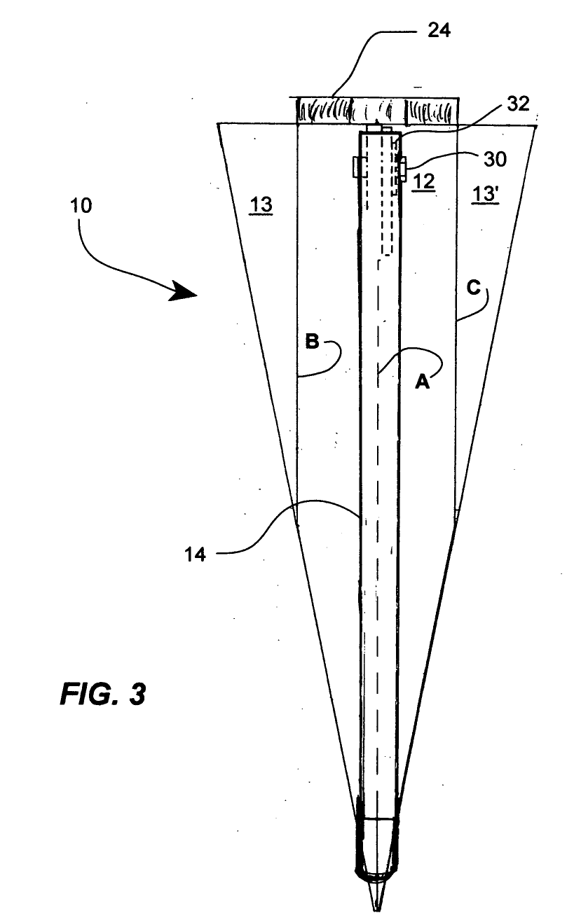

FIG. 3 Front view of the anchoring device.

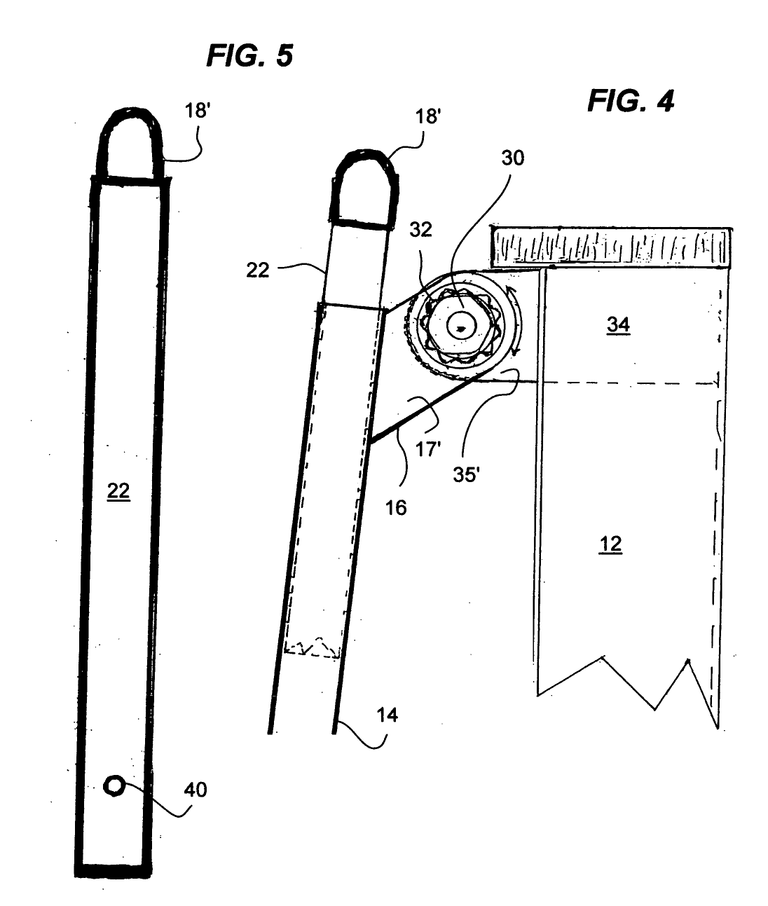

FIG. 4 Side view detail of the multipoint adjustment.

FIG. 5 Front view of the secondary arm.

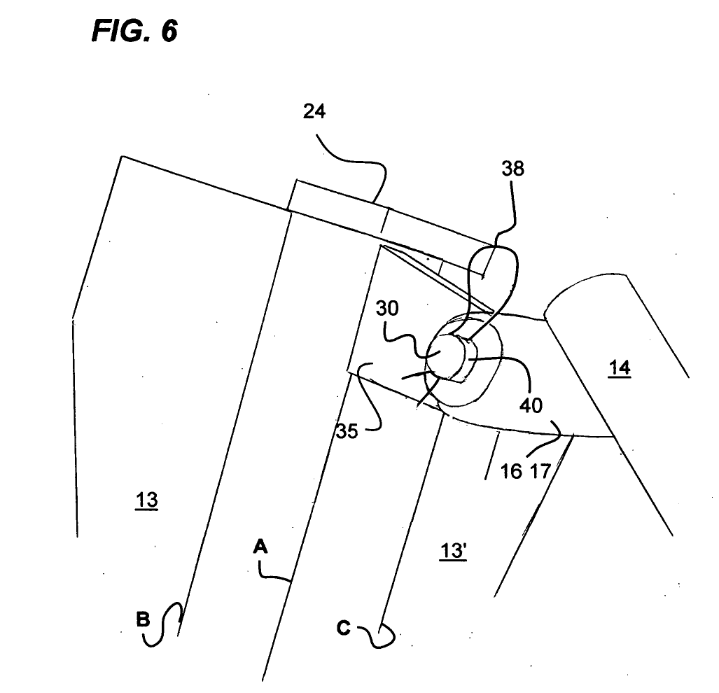

FIG. 6 Isometric view of the multipoint adjustment.

### DETAILED DESCRIPTION OF THE PREFERRED EMBODIMENT

An emergency anchoring device for recreational vehicles(10) has a body (12) which has a generally pointed shape when viewed from the front as in FIG. 4 but also from the side as in FIGS. 1-2. The body has three fold lines A, B, and C with <<A >> being in the middle and <<B >> and <<C >> being paired, one on each sides of <<A >> so as to create folds from which extend wings (13, 13′) that are flat so as to extend the contact surface with the soil once the anchoring device is planted which increases the frictional resistance, thus the anchoring capability. A primary arm (14) is rotationally attached to the body (12) by way of an adjustable attachment means (16) which will be further discussed later. The primary arm (14) has a hook (18) at its distal end (19) (in relation to the adjustable attachment means (16)). The primary arm (14) is hollow so that it can contain within its hollow a secondary arm (22) configured and sized to fit within the primary arm (14). The secondary arm (22) can be retracted or protracted and can be positioned so that it can protract from the proximal end (21) or the distal end (19) of the primary arm (14). Changing from proximal to distal end (21, 19) (and vice versa) is done by completely removing the secondary arm (22) from the primary arm (14) and reinserting it into the desired end (19 or 21). Both the primary and the secondary arms (14, 20) have a hook (18,18′) from which a cable, rope or chain can be hooked.

The body has a pointed tip end (20) and a re-enforced head (24) at its opposite end. This re-enforced head (24) can receive impact from an impacting device such as a hammer, sledge or shovel and is used for planting the anchoring device (10) in the ground. The adjustable attachment means (16) is comprised of a nut (30) attached to the end of a shaft (40) which engages into complementary notches (32), part of the attachment means (16). The nut (30) allows for rotational connection between the attachment means (16) and an extension (34) extending from the body (12). By removing a clip (38) passing through a shaft (40), part of the nut (30), the nut (30) is pulled out so as to disengage from the notches (32) which allows rotation of the primary arm (14) so that it can be oriented to any desired angle in relation to the body (12). Once that is done, the nut (30) is pushed back in so that it engages the notches (32) and the clip (38) is clipped so as to lock the nut (30) in place.

Although the anchoring device (10) is functional without the secondary arm (22), it is a nice feature to have and the fact that it can be slid inside the handle (14) allows for unobtrusive storage but also provides extended leverage when it is needed for removing the anchor, either by jiggling it when partially engaged into the handle (14) or when engaged onto the connector head (24). Also, depending upon the orientation of the secondary arm (22), its hook (18′) can be located proximal the attachment means (16) or higher which provides for the possibility of attaching a hoist cable (not shown) above or relatively above the body (12). Also, the secondary arm (22) has at least one adjustment hole (40) that allows passage of an adjustment bolt (42) used when the secondary arm (22) is inserted through the distal end (19) as shown in FIG. 2 but protracted further than illustrated. This allows for alternate tying arrangements according to what the situation requires. For example, if both arms (14,22) are set at a right angle in relation to the body (12), the leverage exerted onto the anchoring device (10) is different than if both arms (14,22) are arranged parallel to the anchoring device (10) as in, for example, FIG. 4.

The adjustment bolt (42) is preferably threadably engaged to the secondary arm (22) or the primary arm (14). However, the adjustment bolt (42) can be replaced by any other mechanical equivalent secondary arm (22) adjustment means.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An emergency anchoring device for recreational vehicles comprising:
a body having a pointed end;
said body having three fold lines with one said fold line being in the middle of said body while the other said fold lines being paired, one on each sides of said middle fold line so as to create folds from which extend wings;
a primary arm rotationally attached to said body by way of an adjustable attachment means;
said primary arm having a hook at its distal end.

2. An emergency anchoring device for recreational vehicles as in claim 1 wherein:
there is a secondary arm, configured and sized to fit within said primary arm so that it can be retracted and protracted in relation with said primary arm; said secondary arm having a hook at one of its end.

3. An emergency anchoring device for recreational vehicles as in claim 1 wherein:
said anchoring device having a re-enforced head at its end opposite said pointed end.

4. An emergency anchoring device for recreational vehicles as in claim 1 wherein:
said adjustable attachment means having of a nut which engages into complementary notches which are conjoined with said attachment means;
said nut allowing for rotational connection between said attachment means and an extension extending from said body;
said extension being fixedly attached to said body.

5. An emergency anchoring device for recreational vehicles as in claim 4 with an adjustable attachment means having the following method of use:
removing a clip passing through a shaft, part of said nut allows said nut to disengage from said notches, which allows rotation of said primary arm so that said primary arm can be oriented to any desired angle in relation to said body;
once orientation of said primary arm is obtained, said nut is pushed back into said notches and said clip is clipped back through said shaft so as to lock said nut in place.

6. An emergency anchoring device for recreational vehicles as in claim 2 wherein:
said secondary arm having at least one adjustment hole that allows passage of an adjustment bolt used when said secondary arm is inserted through said distal end.

7. An emergency anchoring device for recreational vehicles as in claim 6 wherein:
said adjustment bolt being preferably threadably engaged to at least one of said secondary arm or said primary arm.

8. An emergency anchoring device for recreational vehicles comprising:
a body having a pointed end;
said body having three fold lines with one said fold being in the middle of said body while the other said fold lines being paired, one on each sides of said middle fold line so as to create folds from which extend wings;
a primary arm rotationally attached to said body by way of an adjustable attachment means;
said primary arm having a hook at its distal end;
a secondary arm, configured and sized to fit within said primary arm so that it can be retracted and protracted in relation with said primary arm;
said secondary arm having a hook at one of its end;
said anchoring device having a re-enforced head at its end opposite said pointed end.
